(19) United States
(12) Patent Application Publication
(10) Pub. No.: US 2003/0147329 A1
(43) Pub. Date: Aug. 7, 2003

(54) Optical medium, method, and means of self-destructive optical data

(76) Inventor: David Patrick Burks, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/072,370

(22) Filed: Feb. 7, 2002

(51) Int. Cl. G11B 7/24

(52) U.S. Cl. 369/111; 369/275.4; 369/288

(57) ABSTRACT

An optical medium for storing digital data thereon comprising a sequence of binary indicators on a first layer, a reflective layer disposed on the first layer, and a photosensitive layer disposed on the reflective layer, the reflective layer disposed between the first layer and the photosensitive layer, the photosensitive layer experiencing a perceivable loss of translucence upon exposure to a light source is provided. A method of reading data from an optical medium having a sequence of indicators having a binary value assigned thereto comprising radiating light onto a surface of the optical medium having the sequence of binary indicators disposed thereon through a photosensitive material disposed over the sequence and causing the translucence of the photosensitive material to decrease, detecting light reflected from the surface of the optical medium, and interpreting the reflected light as a binary value.

### TECHNICAL FIELD OF THE INVENTION

This invention relates to data storage technologies and, more particularly, to a optical medium and method of self-destructive optical data.

### BACKGROUND OF THE INVENTION

A digital versatile disc (DVD) is an optical storage medium with greater capacity and bandwidth than comparable compact discs (CDs). Original DVDs were designed to hold up to 4.7 gigabytes of data including audio and one hundred and thirty-three minutes of Moving Picture Experts Group-2 (MPEG-2) formatted video as standardized by International Standard 13818 (IS 13818). Advances in DVD technologies, such as dual siding and multi-layering, have increased the capacity of DVDs even further.

A continuing problem for consumers of the video rental industry is the common incurrence of late fees levied upon expiration of a rental period when the rented media has not been returned. Many video rental retailers typically have various rental periods for different video cassette tapes and DVDs. For example, more recent releases of videos often have a shorter rental period than do videos that have been available for rent for a longer period of time. For a variety of reasons many consumers fail to return rented videos within the allotted rental period and are required to often pay significant late fees prior to renting another video.

One prior attempted solution to the above-described problem was a DVD implementation known as Digital video express (Divx). Divx discs are playable only during a specific period of time. Divx requires a Divx-compatible DVD player that includes a counter. Upon insertion of a Divx formatted disc into a Divx player, the counter would begin making deductions from an allowed viewable period allotment. Upon expiration of the allotment, the player would disable playing of the Divx DVD for which the counter was deducted. A Divx DVD player requires a connection to a telephone outlet and communication capabilities with a server with which the player exchanges billing information. Divx technology is attractive to movie studios and content owners because it facilitates a pay-per view period unavailable through standard DVD formats. Additionally, Divx allows a retailer to collect a rental fee if the Divx DVD is viewed at multiple locations via multiple devices. Furthermore, Divx DVDs could be rented from a retailer and need not be returned. Therefore, consumers need not try to remember video rental due dates and pay late fees.

However, Divx DVD players are not backward-compatible with standard DVD players. Thus, persons having already purchased a standard DVD player prior to the availability of Divx DVD players are more likely to resist Divx technologies. The communication requirements of Divx DVD players are an additional deterrent to potential DVD consumers. For these and other reasons, Divx DVDs and Divx DVD players failed to achieve substantial market acceptance and the format has essentially been eliminated.

### SUMMARY OF THE INVENTION

In accordance with an embodiment of the present invention, an optical medium for storing digital data thereon comprising a sequence of binary indicators on a first layer, a reflective layer disposed on the first layer, and a photosensitive layer disposed on the reflective layer, the reflective layer disposed between the first layer and the photosensitive layer, the photosensitive layer experiencing a perceivable loss of translucence upon exposure to a light source is provided.

In accordance with another embodiment of the present invention, a method of reading data from an optical medium having a sequence of indicators having a binary value assigned thereto comprising radiating light onto a surface of the optical medium having the sequence of binary indicators disposed thereon through a photosensitive material disposed over the sequence and causing the translucence of the photosensitive material to decrease, detecting light reflected from the surface of the optical medium, and interpreting the reflected light as a binary value is provided.

A system of performing a data read from an optical medium having a sequence of indicators having a binary value assigned thereto comprising means for radiating light onto a surface of the optical medium having the sequence of binary indicators disposed thereon through a photosensitive material disposed over the sequence and causing the translucence of the photosensitive material to decrease by an appreciable amount, means for detecting light reflected from the surface of the optical medium, and means for interpreting the reflected light as binary zero or one is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a top plan view of an example conventional optical medium;

FIG. 2 is a cross-sectional view of the optical medium of FIG. 1;

FIG. 3 is a simplified block diagram of an optical medium player that may read data on an optical medium manufactured according to an embodiment of the present invention;

FIGS. 4A and 4B are simplified cross-sectional diagrams of a portion of an optical medium manufactured according to the prior art having a beam of light radiated from a laser impinging thereon;

FIG. 5 is a simplified cross-sectional diagram of an optical medium;

FIG. 6 is a simplified cross-sectional diagram of an optical medium manufactured according to an embodiment of the present invention; and

FIGS. 7A-7C are respective simplified cross-sectional diagrams of an optical medium manufactured according to an embodiment of the invention and having light emitted thereon.

### DETAILED DESCRIPTION OF THE DRAWINGS

The preferred embodiment of the present invention and its advantages are best understood by referring to FIGS. 1 through 7 of the drawings, like numerals being used for like and corresponding parts of the various drawings.

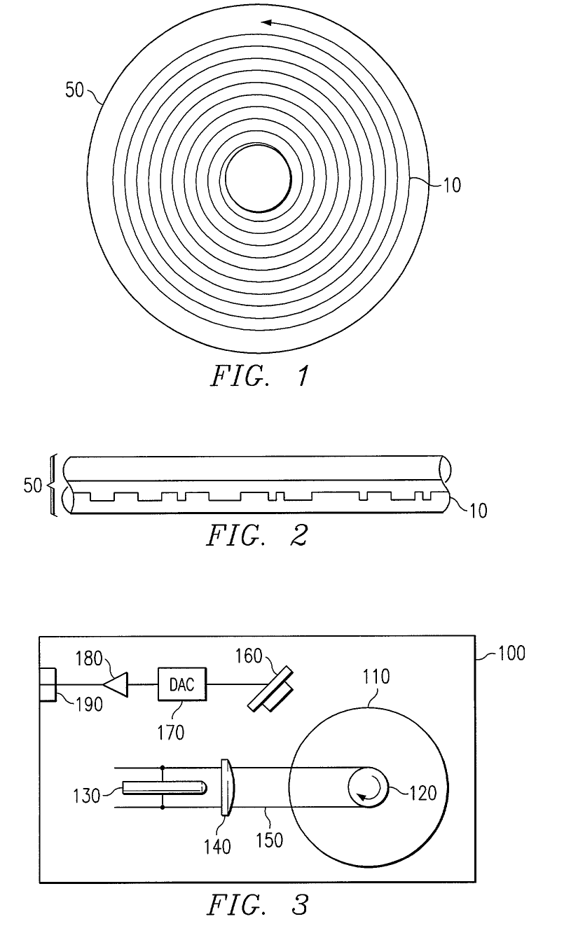

A standard DVD 50 is generally circular, approximately 4.7 inches in diameter, and composed of several layers of plastic having a composite thickness of approximately 1.2 millimeters. Each layer is generally manufactured by an injection molding process that leaves the layers with microscopic pits arranged in a continuous spiral track 10 on DVD 50, as illustrated by the exemplary optical medium in FIG. 1. Adjacent pits of a track are generally separated by 740 nanometers. An thin reflective layer is then added to the surface of the disc. Common manufacturing techniques apply an aluminum layer behind the inner disc layers and a gold layer on an outer layer(s). In FIG. 2, there is illustrated a cross-sectional view of a portion of an optical medium data track 10, such as a portion of spiral track 10 of pits included in DVD 50.

FIG. 3 is a simplified block diagram of an example of an optical medium player that may read data on an optical medium. An optical medium player, such as a DVD player 100, may read DVD 50 and may be implemented to read and facilitate destruction of a DVD according to an embodiment of the invention. DVD player 100 comprises a DVD receptacle 110 operable to accept insertion of DVD 50 therein. A drive motor 120 is operable to spin the disc. DVD player 100 includes a laser 130 for generating a light and impinging the light on DVD 50. A lens 140 may be used to focus the light on the target DVD track. A tracking component 150 facilitates translation of laser 130 and lens 140 across the surface of disc 50 such that the light directed from laser 130 may properly focus on spiral track 10. An optic receiver 160 is operable to receive light reflected from the DVD track. Optic receiver 160 is operable to detect differences in the reflected light due to impingement on a bump or a flat surface of a pit of DVD track 10 and performs a binary interpretation dependent on the reflected light characteristics. Sequences of binary values may be processed by a digital-to-analog converter 170, passed to an amplifier 180 and transmitted to an output interface 190, such as an S-Video output, a plurality of component video output, or another output interface, that may be coupled to a peripheral audio and/or video equipment.

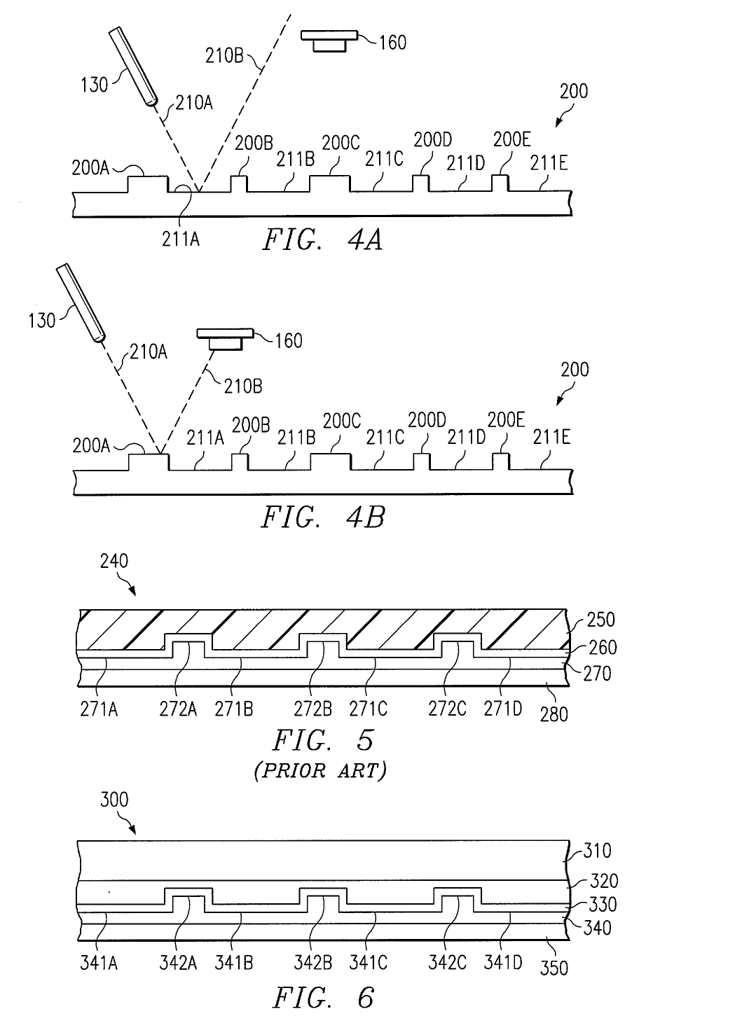

FIG. 4A is a cross-sectional portion 200 of an optical medium data track, such as a DVD track of bumps and pits, having a beam of light 210A radiated from laser 130 impinging thereon. Incident light 210A hits pit 211A and light 210B is reflected therefrom. Optic receiver 160 is positioned to receive light reflected from portion 200 of the DVD track. However, pit 211A fuctions to scatter reflected light 210B, or otherwise diminish the intensity thereof, such that optic receiver 160 interprets reflected light 210B as a binary zero. In FIG. 4B, there is shown portion 200 of a DVD track of bumps and pits after translation of the DVD track, for example rotation of DVD 50 via drive motor 120. Incident light 210A impinges on a bump 211A that reflects light 210B therefrom. Reflected light 210B impinges more directly with optic sensor 160 than does light reflected from one of pits 211A-211E and is accordingly interpreted by optic sensor or other DVD player circuitry as a binary 1.

In FIG. 5, there is shown a simplified side-sectional illustration of a portion of a conventionally-manufactured optical medium 240. DVD 240 may comprise a non-translucent layer 280 on which labels are typically affixed or printed. Dual-sided DVDs do not generally include non-translucent layer 280. A protective layer, such as an acrylic layer 270, may be disposed intermediate non-translucent layer 280 and a reflective layer 260 having a spiral pattern of bumps 272A-272C and pits 271A-271D pressed, or stamped, thereon. Acrylic layer 270 is coated with a reflective layer 260, such as an aluminum layer and/or gold layer, that yields a surface readable by player 100. A transparent layer 250, such as a thermoplastic, is generally disposed on reflective layer 260 opposite acrylic layer 270 to protect the readable surface from scratches and debris. Data is read from optical medium 240 by passing light through transparent layer 250 and onto reflective layer 260. An optic system may then be used to interpret light reflected from reflective layer 260, or the lack thereof, and assign a binary value thereto.

FIG. 6 is a simplified cross-sectional diagram of a portion of an optical medium 300 manufactured according to an embodiment of the present invention. Optical medium 300 comprises a protective layer 340, such as an acrylic layer, having a series of bumps 342A-342C and pits 341A-341D coated with a reflective layer 330. A protective translucent layer 310 may be included within optical medium 300 to protect the readable surface formed by reflective layer 330. A photosensitive layer 320 may be disposed between reflective layer 330 and translucent layer 310 according to an embodiment of the invention. Photosensitive layer 320 is preferably composed of a photosensitive dye that is translucent prior to being heated and/or radiated with light. For example, photosensitive layer 320 may be translucent until heated by light from a laser of a particular frequency, such as a 650 nanometer red spectrum laser, and/or intensity upon which the dye reacts and obtains a perceivable degree of opaqueness. Dependent on the sensitivity of photosensitive layer 320, a single exposure to light emitted from laser 130 may result in photosensitive layer 320 having an immediate reduction in the translucence thereof to cause the reading of the series of bumps and pits to be impossible. Alternatively, photosensitive layer 320 may be formulated such that a gradual predetermined loss of translucence is achieved with each exposure to light emitted from laser 130. In general, light from laser 130 is sufficient, either through a single exposure or a predetermined number of exposures, to reduce the translucence of photosensitive layer 320 such that the intensity of light reflected therefrom and impinging on optic receiver 160 of DVD player 100 is insufficient to be interpreted as a binary one. Accordingly, either over a single reading of DVD 300 or multiple readings, depending on the particular embodiment, photosensitive layer 320 becomes opaque to such an extent that data stored on optical medium 300 is destroyed and the optical medium is unreadable.

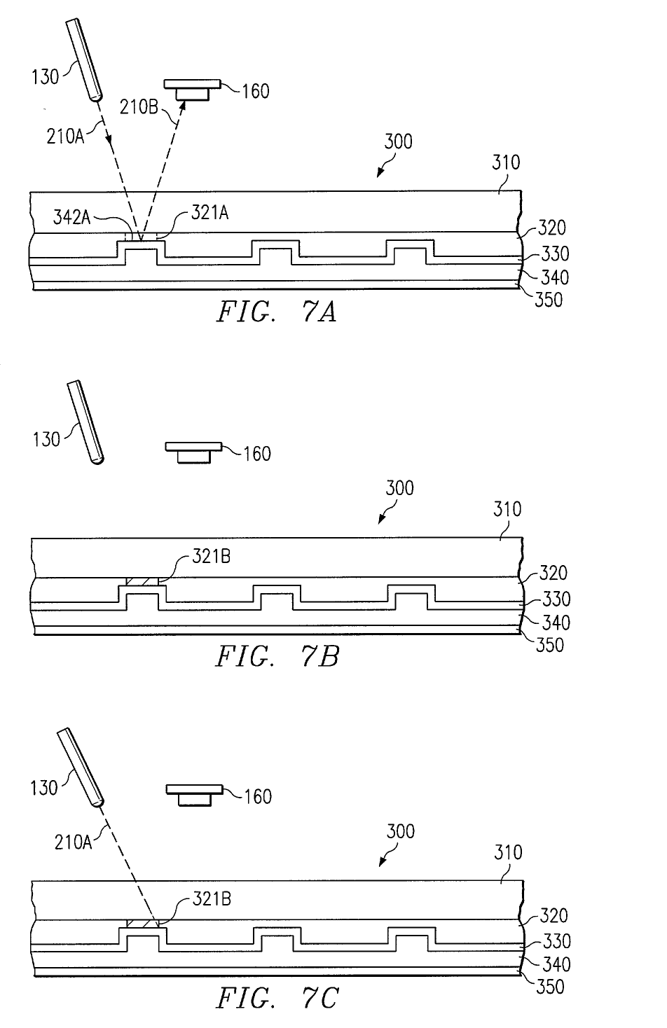

With reference now to respective FIGS. 7A-7C, there is a simplified cross-sectional diagram of a data track portion of optical medium 300 manufactured according to an embodiment of the invention and having a beam of light 210A radiated from laser 130 impinging thereon. Incident light 210A passes through translucent layer 310, through adjacent photosensitive layer 320, and, in the illustrative example, impinges bump 342A and light 210B is reflected therefrom. Optic receiver 160 is positioned to receive light 210B reflected from reflective layer 330 through photosensitive layer 320 and translucent layer 310.

As described hereinabove, photosensitive layer 320, or a portion thereof, may undergo a reaction in response to exposure to light emitted from laser 130. As shown in FIG. 7B, a portion 321B (illustratively denoted with cross hatches) of photosensitive layer 320 undergoes a reaction during and/or after passage of light from laser 130 therethrough. Portion 321B is, in general, less translucent than an identical area 321A after passage of incident light 210A and/or reflected light 210B therethrough. As shown in FIG. 7C, a decrease of translucence of portion 321B induced by exposure of light thereon, or passage of light therethrough, is preferably sufficient to yield an opaqueness that precludes reflection of light from reflective layer 330. Thus, photosensitive layer 320 becomes sufficiently opaque after one or more exposures to light emitted from laser 130 that incident light 210A is absorbed, or alternatively scattered, dissipated, and/or subjected to destructive interference, such that no light is reflected from reflective layer 330 or light reflected from reflective layer 330 is insufficiently intense or scattered such that reflected light impinging optic sensor 160 is inadequate for a proper binary reading to be performed thereby.

The particular embodiment of an optical medium of the present invention described herein is exemplary only and selected to facilitate an understanding of the invention. Numerous variations of the optical medium are possible. For example, photosensitive layer 320 may be replaced by one or more layers of any one or more various photosensitive chemicals. Furthermore, a photosensitive dye material may be incorporated within translucent layer 310 to achieve similar functions as photosensitive layer 320. For example, traditional CDs and DVDs include a transparent layer 250 (FIG. 5) comprised of a thermoplastic, such as a polycarbonate, that protects the readable surface of the disc without interfering with the passage of light therethrough. The substrate from which the transparent layer is produced may be manufactured with a photosensitive dye that is originally transparent but which loses its translucence upon one or more exposures to light of a particular frequency and/or intensity according to an embodiment of the present invention. Furthermore, a DVD optical medium has been referred to in the abovedescribed embodiments. However, it should be understood that the present invention is applicable to numerous storage devices and techniques such as compact discs storing digitally formatted audio or computer-readable data such as software applications. For example, commercial software is often distributed on compact disc. The present invention is suitable for, and may provide advantage to, distribution of commercial software applications by facilitating a limited number of software reads from a compact disc. Moreover, the illustrative examples, and the accompanying discussion, have been limited to an optical medium having a track of data on a single layer of the optical medium. It should be understood that the present invention may be applied to optical mediums having multiple layers of data tracks, such as dual-sided or multi-layered DVDs.

What is claimed is:

1. An optical medium for storing digital data thereon, comprising:
a sequence of binary indicators on a first layer;
a reflective layer disposed on the first layer; and
a photosensitive layer disposed on the reflective layer, the reflective layer disposed between the first layer and the photosensitive layer, the photosensitive layer experiencing a perceivable loss of translucence upon exposure to a light source.

2. The optical medium according to claim 1, wherein the photosensitive layer comprises a photosensitive dye.

3. The optical medium according to claim 1, further comprising a protective transparent layer, the photosensitive layer disposed between the transparent layer and the reflective layer.

4. The optical medium according to claim 1, further comprising a protective transparent layer, the photosensitive layer integrated within the protective transparent layer.

5. The optical medium according to claim 3, wherein the transparent layer comprises a thermoplastic.

6. The optical medium according to claim 1, wherein the first layer comprises an acrylic.

7. The optical medium according to claim 1, wherein the sequence of binary indicators comprises a sequence of pits and bumps arranged in a spiral pattern disposed on the first surface of the medium.

8. The optical medium according to claim 1, wherein the sequence of binary indicators comprises moving pictures expert group-2 formatted video.

9. The optical medium according to claim 1, wherein the sequence of binary indicators comprises digitally formatted audio.

10. The optical medium according to claim 1, further comprising:
a plurality of sequences of binary indicators; and
a plurality of reflective layers each respectively disposed on the first layer having one of the plurality of sequences of binary indicators.

11. The optical medium according to claim 1, wherein the reflective surface is selected from the group consisting of aluminum and gold.

12. A method of performing a data read from an optical medium having a sequence of indicators having a binary value assigned thereto, comprising:
radiating light onto a surface of the optical medium having the sequence of binary indicators disposed thereon through a photosensitive material disposed over the sequence and causing the translucence of the photosensitive material to decrease;
detecting light reflected from the surface of the optical medium; and
interpreting the reflected light as a binary value.

13. The method according to claim 12, wherein the decrease of the translucence causes the interpretation of at least a portion of the binary sequences to deviate from the binary value assigned thereto at a next data read of the optical medium.

14. The method according to claim 12, wherein the decrease of the translucence causes the interpretation of at least a portion of the binary sequences to deviate from the binary value assigned thereto after a plurality of later data reads from the optical medium.

15. The method according to claim 12, wherein radiating light onto a surface of the optical medium having the sequence of binary indicators disposed thereon further comprises radiating light onto a surface of the optical medium having a sequence of pits and bumps arranged in a spiral on the surface.

16. The method according to claim 12, further comprising radiating light through a protective transparent layer of the optical medium, the photosensitive material disposed intermediate the protective transparent layer and the surface of the optical medium having the sequence of binary indicators disposed thereon.

17. The method according to claim 12, further comprising radiating light through a protective transparent layer comprising the photosensitive material.

18. A system of performing a data read from an optical medium having a sequence of indicators having a binary value assigned thereto, comprising:
means for radiating light onto a surface of the optical medium having the sequence of binary indicators disposed thereon through a photosensitive material disposed over the sequence and causing the translucence of the photosensitive material to decrease by an appreciable amount;
means for detecting light reflected from the surface of the optical medium; and
means for interpreting the reflected light as binary zero or one.

19. The system according to claim 18, wherein the decrease of the translucence causes the interpretation of at least a portion of the binary sequences to deviate from the binary value assigned thereto at a next data read of the optical medium.

20. The system according to claim 18, wherein the decrease of the translucence causes the interpretation of at least a portion of the binary sequences to deviate from the binary value assigned thereto after a plurality of later data reads from the optical medium.
